(19) United States
(12) Patent Application Publication
(10) Pub. No.: US 2006/0071196 A1
(43) Pub. Date: Apr. 6, 2006

(54) Method of wood treatment and solution provided therefore

(76) Inventors: Clayton R. McKee, Greenville, SC (US); Douglas S. Smalley, Portland, OR (US)

Correspondence Address: Joseph T. Guy, Ph.D.;Nexsen Pruet LLC, Suite 400, 201 W. McBee Avenue, Greenville, SC, 29603, US

(21) Appl. No.: 10/950,710

(22) Filed: Sep. 27, 2004

(51) Int. Cl. C09K 3/00

(52) U.S. Cl. 252/380

(57) ABSTRACT

A process and solution for treating wood. The process includes providing a periodic acid concentrate with at least 3 wt % periodic acid neutralized to a pH of at least 4 with at least one base selected from sodium hydroxide, potassium hydroxide and ammonium hydroxide. The periodic acid concentrate is diluted to form a treatment periodic acid solution with about 0.01 wt % to about 0.5 wt % periodic acid. Wood is treated with the treatment periodic acid solution to form treated wood.

### BACKGROUND

The present invention is related to an improved treatment of wood and related lignocellulosic materials. More specifically, the present invention is related to a periodic acid solution, and method of use for treating wood and related lignocellulosic materials.

The desire to treat wood products is long standing. It is well known that unprotected wood is highly susceptible to degradation by both chemical and biological attack such as rot, fungus growth, bug infestation and the like. There has been a continuing effort to mitigate these detrimental activities.

Reacting the wood with iodide, in the form of iodic acid or periodic acid, has been described most recently in U.S. Pat. No. 6,537,357 to Wampole, Sr. The activity of iodates has been documented in U.S. Pat. No. 5,470,614 to Chen et al. The activity of periodic acid or sodium periodiate has been documented in Chen et al., “Fungal And Termite Resistance Of Wood Reacted With Periodic Acid or Sodium Periodate”, Wood And Fiber Science, 21(2), 1989, pp. 163-168.

A periodic acid solution has a very low pH such as less than 2. Handling and using low pH material is well understood and commonly done in the art and is therefore not a concern although the low pH was not considered a problem in the prior art specifically as it regards wood, the aggressiveness of the low pH made processing wood in industry standard equipment prohibitive. The concentrate is diluted and the diluted material placed in a large vat. Wood is passed into the vat for a predetermined period of time after which it is removed, rinsed, dried and transported for use. The wood can also be sprayed or the solution can be applied by spaying, brushing or other means. Dipping is preferred due to the simplicity of operation. The iodide is thought to react with the cellulose to form a material which is substantially less susceptible to natural environmental factors. This method has therefore enjoyed some success.

It has come to the attention of the present inventors that deficiencies are encountered with the prior art method which were neither anticipated nor realized for some time. A particular problem is the propensity for the treated wood to maintain a low pH. While previously considered to be of no consequence it has now been determined that the low pH causes oxidation of metal parts which are in sustained contact with the wood. Framing members such as nails, truss braces and the like tend to oxidize over time thereby compromising the structural integrity of any product assembled therewith. It has therefore become a critical desire to raise the pH towards neutral.

Unfortunately, raising the pH has proven to be difficult due, in part, to the low solubility of suitable bases. If a low solubility base was used the material had to be transported in larger volumes thereby rendering the material commercially unfeasible.

Through diligent research the applicants have developed an understanding of a previously unrealized problem in the art. The problem of metal deterioration has been resolved by the present invention. In addition to discovering, and resolving, the problem associated with metal deterioration the Applicants have developed a formulation for treating wood and lignocellulosic materials which has improved stability, can be transported in high concentration and is less corrosive to preparation equipment and construction materials.

### SUMMARY OF THE INVENTION

It is an object of the present invention to provide an improved method for treating wood and lignocellulosic materials.

It is a particular object of the present invention to provide a method for treating wood and lignocellulosic materials with periodic acid at a higher pH than previously considered.

A particular feature of the present invention is the mitigation of corrosion of metal parts in contact with treated wood.

A particular advantage of the present invention is the ability to transport concentrate at a higher concentration thereby decreasing material transport cost. A higher pH also facilitates storage and transport.

These and other advantages, as will be realized, are provided in a process for treating wood. The process comprises providing a periodic acid concentrate neutralized to a pH of at least 4 with at least one base selected from sodium hydroxide, potassium hydroxide and ammonium hydroxide. The periodic acid concentrate is diluted to form a treatment periodic acid solution comprising about 0.01 wt % to about 0.5 wt % periodic acid. Wood is treated with the treatment periodic acid solution to form treated wood.

Yet another advantage is provided in a solution for treating wood comprising at least 3 wt % periodic acid neutralized to a pH of at least 4 with at least one base selected from sodium hydroxide, potassium hydroxide and ammonium hydroxide.

Yet another advantage is provided in wood protected from degradation prepared by the process of: (a) providing a periodic acid concentrate neutralized to a pH of at least 4 with at least one base selected from sodium hydroxide, potassium hydroxide and ammonium hydroxide; (b) diluting the periodic acid concentrate to form a treatment periodic acid comprising about 0.01 wt % to about 0.5 wt % periodic acid; and (c) treating wood in the diluted solution to form treated wood.

### DETAILED DESCRIPTION

The present invention is directed to an improved periodic acid solution neutralized by a select base to a pH of at least 4 and transportable as a concentrate.

The periodic acid will be described in terms of a periodic acid concentrate and a treatment periodic acid. In use the concentrate is transported and an aliquot of the concentrate is diluted to form the treatment periodic acid.

The periodic acid concentrate comprises an aqueous solution of at least 3 wt % periodic acid neutralized to a pH of at least 4 with sodium hydroxide, potassium hydroxide or ammonium hydroxide. Ammonium hydroxide is most preferred due to the improved solubility of the ammonium periodate.

It is preferred that the pH be less than 7 due to the propensity for formation of iodide dimers in caustic solution. It is most preferred that the pH level be at least 5. When galvanized metal is to be used for trusses, nails or other material contacting the treated lumber it is preferred that the pH be at least about 5.5 to about 6.5. When carbon steel is to be used for trusses, nails or other material contacting the treated lumber it is preferred that the pH be at least about 6 to about 6.5.

The wt % periodic acid in the periodic acid concentrate is limited by the solubility. A periodic acid concentrate comprising at least 10 wt % periodic acid is preferable with about 11-14 wt % being most preferred. A periodic acid concentrate with about 12.5 wt % has been determined to be optimum to minimize transport volumes while safely avoiding the onset of precipitation which typically occurs at about 18 wt % periodic acid using ammonia as the neutralizing base at a pH above about 4.

Prior to use the periodic acid concentrate is diluted, preferably with water. The dilution is preferably sufficient to dilute the periodic acid concentrate to form a treatment periodic acid with at least about 0.01 wt % to no more than about 0.5 wt % periodic acid. Below about 0.01 wt % periodic acid the concentration of the periodic acid is insufficient to be effective at modifying the wood. Above about 0.5 wt % the effectiveness does not increase to an amount sufficient to justify the additional material cost and therefore diminished returns are reached. For treatment at atmospheric pressure a periodic acid concentration of about 0.06 wt % in the treatment solution is preferred. For treatment at pressure above or below atmospheric pressure a periodic acid concentration of about 0.03 wt % in the treatment solution is preferred.

The periodic acid concentrate, or the treatment periodic acid, may further comprise adjuvants to impart particular properties on the solution. Acid corrosion inhibitors, biological and mold inhibitors, surfactants, anti-foam agents, antioxidants, odorants, flame retardants or colorants can be added as desired. The amount of such optional additives included in the compositions of the invention may vary over a wide range although amounts of from about 0.01 to about 5% of the total composition is sufficient. It is preferable that the adjuvants be added to the periodic acid concentrate to minimize shipping of multiple containers.

Wood is typically in the presence of the treatment periodic acid for about 5 to 30 minutes at atmospheric pressure. It is often preferred to use a pressure which differs from atmospheric pressure. Pressures above, or below, atmospheric pressure are considered to be beneficial.

When pressures above atmospheric pressure are used the solution is thought to be forced into the interior of the wood for improved distribution. When pressure below atmospheric pressure are used the wood if first maintained in a chamber wherein a reduced pressure is applied. While not limited to any theory, it is thought that the water within the wood is extracted at lower pressure. The periodic acid solution is then allowed to flow into the chamber wherein it replaces the extracted water. For example, wood can be treated at about 150 lb/in² for 15 minutes to achieve an effective saturation of about 3.2 gallons/ft³. Alternatively, wood can be subjected to a pressure which is about 25 lb/in² below atmospheric pressure for about 30 minutes followed by flooding the chamber with periodic acid solution to achieve adequate saturation. One of skill in the art could easily optimize the pressure and time for optimum performance in various applications.

Elevated temperatures can be employed but it is not necessary. The wood is preferably treated by passing the wood through a treatment periodic acid solution in a vat sufficiently large to contain a sufficient number of wood pieces to be economically feasible. The wood can be submerged or allowed to float with rotation to insure complete coverage. The treatment periodic acid can also be applied by spraying or coating but dipping is preferably due to the simplicity of operation. Combinations can be employed such as a pre-spray followed by a dipping.

After application of the periodic acid solution the wood can be rinsed, preferably with water, and either allowed to dry under ambient conditions or dried in a kiln. After drying the wood is suitable for use in outdoor environments.

Biological inhibitors including mold inhibitors, microbiocides, fungicides, and insecticides can be incorporated into either of the periodic acid concentrate or the treatment periodic acid. Biologicial inhibitors can be added in amounts from about 0.05 to 5,000 ppm based on the periodic acid concentrate. Exemplary biological inhibitors include 3-isothiazolones including 5-chloro-2-methyl-3-isothiazolone, 2-methyl-3-isothiazolone, 5-chloro-2-ethyl-3-isothiazolone, 2-ethyl-3-isothiazolone, 4,5-dichloro-2-methyl-3-isothiazolone, 1,2-benz-3-isothiazolone, 4,5-trimethylene-2-methyl-3-isothiazolone; 2-(4-trifluoro-methoxyphenyl)-3-isothiazolone; 2-(4-trifluoromethoxy-phenyl)-5-chloro-3-isothiazolone, 2-(4-trifluoromethoxyphenyl)-4,5-dichloro-3-isothiazolone and mixtures thereof; carbamates such as 3-iodo-2-propynylbutylcarbamate, manganese ethylenebisdithiocarbamate, zinc ethylenebisdithiocarbamate and zinc dimethyl dithiocarbamate; cyanoalkanes such as 1,2-dibromo-2,4-dicyanobutane; isocyanates such as methylene-bis-thiocyanate; benzothiazoles such as 2-thiocyano-methylthiobenzothiazole; tetrachloroisophthalonitrile; dioxanes such as 5-bromo-5-nitro-1,3-dioxane, alcohols such as pentachlorophenol, 2-bromo-2-nitropropane-1,3-diol, 5-chloro-2-(2,4-dichlorophenoxy)-phenol; 2,2-di-bromo-3-nitrilopropionate, hydantoins such as N,N′-dimethylhydroxyl-5,5′-dimethyl-hydantoin or bromocholorodimethylhydantoin; 3,4,4′-trichlorocarbanilide; copper salts such as copper naphthenate, copper-8-hydroxy-quinoline; boron derived compounds such as zinc borate, boric acid, trimethyl boron; zinc oxide; glutaraldehyde, 1,4-dichloro-1,1-diathiacyclopentene-3-one, chlorothalonil ; triazines such as 2-methyl-4-t-butylamino-6-cyclopropylamino-s-triazine; nitrites such as 2,4,5,6-tetrachloroisophthalonitrile; urea deriviatives such as N,N-dimethyl dichlorophenyl urea; copper complexes such as copper thiocyanate; phthalimide compounds such as N-(fluorodichloromethylthio)phthalimide; thiosulfamides such as N,N-dimethyl-N′-phenyl-N′-fluorodichloromethylthiosulfamide; copper, sodium and zinc salts of 2-pyridinethiol-1-oxide; disulfides such as tetramethylthiuram disulfide, polyethylene thiuram disulfide; maleimides such as 2,4,6-trichlorophenyl-maleimide; pyridines such as 2,3,5,6-tetrachloro-4-(methylsulfonyl)-pyridine; sulfones such as diiodomethyl p-tolyl sulfone; bismuth dichloride; benzimidazoles such as 2-(4-thiazolyl)-benzimidazole; boranes such as pyridine triphenyl borane; amides such as phenylamide, halopropargyl compounds; propiconazole; cyproconazole; tebuconazole; nitrophenyl derivatives such as 2-sec-butyl-4,6-dinitrophenyl isopropyl carbonate; methoxyacrylates such as methyl (E)-2-(2-(6-(2-cyanophenoxy-pyrimidin-4-yloxy)phenyl)-3-methoxyacrylate; benzo(1,2,3)thiadiazole-7-carbothioic acid S-methyl ester; heterocyclic aromatic amides as described in U.S. Pat. No. 6,706,740; quaternary ammonium compounds such as didecyldimethylammonium chloride and those described in U.S. Pat. No. 5,833,741.

Surfactants can be incorporated to improve wetting of the surface, to improve rheology and other reasons as know in the art. The surfactant is not particularly limiting. Representative surfactants include phenols such as phenol (poly)alkylene glycol ethers; nonaromatic surfactants such as those comprising ethylene oxide propylene oxide and butylenes oxide units; fatty alcohols having 10-24 carbon atoms and alkyl oxides including anionic derivitized compounds comprising carboxylates, sulfonates, sulfates, phosphates, amines or alkanolamines; ethoxylated nonylphenol, preferably with linear nonyl group; fluorinated surfactants particularly comprising perfluorinated chains; hydroxypropyl cellulose; sulfuric acid salts, aliphatic sulfonic acid salts, aromatic sulfonic acid salts, amido sulfuric acid salts, ether carboxylic acid salts, amides, esters, ethers, alcohols, phosphoric acid esters, phenyl ether, higher fatty acid alkanolamides, having a linear or branched chain alkyl or alkenyl structural moiety, and those compounds to which one or more components out of ethylene oxide, propylene oxide, and butylene oxide are added; amino acid type surfactants; sulfonic acid type amphoteric surfactants; betaine type amphoteric surfactants; amine oxides; sucrose fatty acid esters; aliphatic glycerin monoesters and tetraalkylammonium type cationic surfactants. Anionic or nonionic surfactants may be used. Many such surfactants are known in the art. See, for example, McCutcheon's “Detergents and Emulsifiers”, 1979, North American Edition, published by McCutcheon's Division, MC Publishing Corporation, Gen Glen Rock, N.J., U.S.A., particularly pages 15-20 which are hereby incorporated by reference for their disclosure in this regard. In general, nonionic surfactants such as those containing ether linkages are particularly useful. Nonionic polyoxyethylene compounds of this type are described in U.S. Pat. No. 3,855,085. Such polyoxyethylene compounds are available commercially under the general trade designations “Surfynol” by Air Products and Chemicals, Inc. of Allentown, Pa., and under the designation “Pluronic” or “Tetronic” by BASF Wyandotte Corp. of Wyandotte, Mich. Examples of specific polyoxyethylene condensation products include “Surfynol 465” which is a product obtained by reacting about 10 moles of ethylene oxide with 1 mole of tetramethyldecynediol. “Surfynol 485” is the product obtained by reacting 30 moles of ethylene oxide with tetramethyldecynediol. “Pluronic L 35” is a product obtained by reacting 22 moles of ethylene oxide with polypropylene glycol obtained by the condensation of 16 moles of propylene oxide. Also useful is Atlox 1045A from ICI America, Inc. Which is a polyoxyalkylene sorbitol oleate-laurate mixture. Amine, long chain fatty amine, long chain fatty acid, alkanol amines, diamines, amides, alkanol amides and polyglycol-type surfactants known in the art are also useful. More specifically, compounds formed by the addition of propylene oxide to ethylene diamine followed by the addition of ethylene oxide are useful and are available commercially from BASF Wyandotte Inc. Chemical Group under the general trade designation “Tetronic”. The preferred surfactants include nonylphenol ethoxylate or linear alcohol ethoxylate. Other known nonionic glycol derivatives such as polyalkylene glycol ethers and methoxy polyethylene glycols which are available commercially can be utilized as surfactants in the compositions of the invention. Anionic surfactants also are useful in the aqueous systems of the invention. Among the useful anionic surfactants are the widely-known metal carboxylate soaps, organo sulfates, sulfonates, sulfocarboxylic acids and their salts, and phosphates. Various anionic surfactants are readily available commercially, and further information about anionic surfactants can be found in the test “Anionic Surfactants” Parts II and III, edited by W. M. Linfield, published by Marcel Dekker, Inc., N.Y., 1976. Examples of anionic surfactants available from ICI America, Inc. include Atlas G-2205 which is an aromatic phosphate and Atlas G-3300 which is an alkyl aryl sulfonate. Examples of anionic surfactants available from Rohm & Haas Company include Triton 770 which is a dioctyl sodium sulfosuccinate, Triton H-55 which is a phosphate surfactant, potassium salt, Triton W-30 and Triton X200 which are sodium salts of alkyl aryl polyether sulfonates, etc. Mixtures of the nonionic and anionic surfactants can and are generally utilized in the aqueous systems of the present invention.

Carbowax-type agents which are polyethylene glycols having different molecular weights may be employed. For example Carbowax No. 1000 has a molecular weight range of from about 950 to 1050 and contains from 20 to 24 ethoxy units per molecule. Carbowax No. 4000 has a molecular weight range of from about 3000 to 3700 and contains from 68 to 85 ethoxy units per molecule. One of skill in the art would realize that it is preferred to incorporate carbowax-type agents in a separate step after reaction with periodic acid. Carbowaxe is know to inhibit water absorption and it is therefore preferred to be used after periodic acid treatment to further protect the wood.

Inorganic fire retardant compositions are particularly useful in the compositions of the invention. Examples of inorganic materials include metal oxides which are well known in the art such as antimony oxide, etc. Examples of organic fire retardants include a number of halogenated and organophosphorus compounds which may be dispersed in the solutions. Other examples include diammonium phosphate, monoammonium phosphate, ammonium chloride, ammonium sulfate, borax, zinc chloride, orthophosphoric acid, boric acid, ammonium sulfamate, hydrate of sodium oxyfluoroborate, ammoniacal basic zinc chloride, disodium octaborate tetrahydrate, ammonium diborate, ammonium pentaborate and mixtures thereof.

Iodide solutions are known to be susceptible to degradation in light. This can be combated with opaque containers and low light environments. It is also desirable to incorporate colorants in the solution to absorb light and decrease the propensity for solutions to degrade. Carbon black is a particularly preferred colorant for protection of the solution from ultra-violet radiation.

It is known in the art to use specific colorants to indicate which type of treatment the wood has been subjected to. The present invention is compatible with the standard protocols for coloring wood to indicate the treatment method.

### EXAMPLES

A periodic acid concentrate was prepared by neutralizing a periodic acid concentrate to a pH of about 5.8 to 6.5 with about 30% ammonium hydroxide. Nonylphenol ethoxylate or linear alcohol ethoxylate surfactants were added at a concentration of about 0.3 wt %. The periodic acid concentrate was then diluted about 50:1 to form a treatment periodic acid solution comprising about 0.055 wt % periodic acid. Wood was treated with the inventive solution and with a solution prepared according to U.S. Pat. No. 6,537,357. The treated wood was then placed into contact with various forms of construction material including carbon steel, galvanized steel, aluminum, copper and zinc. Visible corrosion was observed on some samples as early as about 10 minutes after contact with the solution prepared according to U.S. Pat. No. 6,537,357 and by two days most samples had visible corrosion. With the inventive solution no corrosion was observed after about 30 days.

1. A process for treating wood comprising:
providing a periodic acid concentrate neutralized to a pH of at least 4 with at least one base selected from sodium hydroxide, potassium hydroxide and ammonium hydroxide;
diluting said periodic acid concentrate to form a treatment periodic acid solution comprising about 0.01 wt % to about 0.5 wt % periodic acid; and
treating wood with said treatment periodic acid solution to form treated wood.

2. The process for treating wood of claim 1 wherein said treatment periodic acid solution comprises about 0.03 wt % periodic acid.

3. The process for treating wood of claim 2 wherein said treatment periodic acid solution comprises about 0.06 wt % periodic acid.

4. The process for treating wood of claim 1 wherein said pH is at least 5.

5. The process for treating wood of claim 4 wherein said pH is from about 5.5 to about 6.5.

6. The process for treating wood of claim 5 wherein said pH is from about 6 to about 6.5.

7. The process for treating wood of claim 1 wherein said pH is less than about 7.

8. The process for treating wood of claim 1 wherein said base is selected from sodium hydroxide and ammonium hydroxide.

9. The process for treating wood of claim 6 wherein said base is ammonium hydroxide.

10. The process for treating wood of claim 1 wherein said periodic acid concentrate comprises at least 3 wt % periodic acid.

11. The process for treating wood of claim 10 wherein said periodic acid concentrate comprises at least 10 wt % periodic acid.

12. The process for treating wood of claim 11 wherein said periodic acid concentrate comprises at least 11 wt % periodic acid to no more than about 14 wt % periodic acid.

13. The process for treating wood of claim 1 wherein said treatment periodic acid solution further comprises a colorant.

14. The process for treating wood of claim 13 wherein said colorant is carbon black.

15. The process for treating wood of claim 1 wherein said treatment periodic acid solution further comprises a surfactant.

16. The process for treating wood of claim 15 wherein said surfactant is selected from nonylphenol ethoxylate and linear alcohol ethoxylate.

17. The process for treating wood of claim 1 wherein said periodic acid concentrate is diluted with water.

18. The process for treating wood of claim 1 wherein said treating includes dipping said wood.

19. The process for treating wood of claim 1 wherein said treating wood is done at atmospheric pressure.

20. The process for treating wood of claim 1 wherein said treating wood is done above atmospheric pressure.

21. The process for treating wood of claim 1 further comprising subjecting wood to a pressure below atmospheric pressure prior to said treating wood.

22. The process for treating wood of claim 1 further comprising rinsing said treated wood.

23. Wood treated with the process of claim 1.

24. A solution for treating wood comprising at least 3 wt % periodic acid neutralized to a pH of at least 4 with at least one base selected from sodium hydroxide, potassium hydroxide and ammonium hydroxide.

25. The solution for treating wood of claim 24 wherein said pH is at least 5.

26. The solution for treating wood of claim 25 wherein said pH is from about 5.5 to about 6.5.

27. The solution for treating wood of claim 26 wherein said pH is from about 6 to about 6.5.

28. The solution for treating wood of claim 24 wherein said pH is less than about 7.

29. The solution for treating wood of claim 24 wherein said base is selected from sodium hydroxide and ammonium hydroxide.

30. The solution for treating wood of claim 29 wherein said base is ammonium hydroxide.

31. The solution for treating wood of claim 24 wherein said periodic acid concentrate comprises at least 10 wt % periodic acid.

32. The solution for treating wood of claim 31 wherein said periodic acid concentrate comprises at least 11 wt % periodic acid to no more than about 14 wt % periodic acid.

33. The solution for treating wood of claim 24 further comprises a colorant.

34. The solution for treating wood of claim 33 wherein said colorant is carbon black.

35. The solution for treating wood of claim 24 further comprises a surfactant.

36. The solution for treating wood of claim 35 wherein said surfactant is selected from nonylphenol ethoxylate and linear alcohol ethoxylate.

37. Wood protected from degradation prepared by the process of:
providing a periodic acid concentrate neutralized to a pH of at least 4 with at least one base selected from sodium hydroxide, potassium hydroxide and ammonium hydroxide;
diluting said periodic acid concentrate to form a treatment periodic acid comprising about 0.01 wt % to about 0.5 wt % periodic acid; and
treating wood in said diluted solution to form treated wood.

38. Wood protected from degradation prepared by the process of claim 37 wherein said treatment periodic acid solution comprises about 0.03 wt % periodic acid.

39. Wood protected from degradation prepared by the process of claim 38 wherein said treatment periodic acid solution comprises about 0.06 wt % periodic acid.

40. The wood of claim 37 wherein said pH is at least 5.

41. The wood of claim 40 wherein said pH is from about 5.5 to about 6.5.

42. The wood of claim 41 wherein said pH is from about 6 to about 6.5.

43. The wood of claim 37 wherein said pH is less than about 7.

44. The wood of claim 37 wherein said base is selected from sodium hydroxide and ammonium hydroxide.

45. The wood of claim 44 wherein said base is ammonium hydroxide.

46. The wood of claim 37 wherein said periodic acid concentrate comprises at least 3 wt % periodic acid.

47. The wood of claim 46 wherein said periodic acid concentrate comprises at least 10 wt % periodic acid.

48. The wood of claim 47 wherein said periodic acid concentrate comprises at least 11 wt % periodic acid to no more than about 14 wt % periodic acid.

49. The wood of claim 37 wherein said diluted solution further comprises a colorant.

50. The wood of claim 49 wherein said colorant is carbon black.

51. The wood of claim 37 wherein said diluted solution further comprises a surfactant.

52. The wood of claim 51 wherein said surfactant is selected from nonylphenol ethoxylate and linear alcohol ethoxylate.

53. The wood of claim 37 wherein said periodic acid concentrate is diluted with water.

54. The wood of claim 37 wherein said treating wood is done at atmospheric pressure.

55. The wood of claim 37 wherein said treating wood is done above atmospheric pressure.

56. The wood of claim 37 further comprising subjecting wood to a pressure below atmospheric pressure prior to said treating wood.

57. The wood of claim 37 further comprising rinsing said treated wood.
